(19) United States
(12) Patent Application Publication
(10) Pub. No.: US 2009/0189748 A1
(43) Pub. Date: Jul. 30, 2009

(54) DEVICE FOR AND METHOD OF PROCESSING AN AUDIO SIGNAL AND/OR A VIDEO SIGNAL TO GENERATE HAPTIC EXCITATION

(75) Inventor: Julien Bergere, Brussels (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,549

(22) PCT Filed: Aug. 23, 2007
(86) PCT No.: PCT/IB2007/053377

§ 371 Date: Feb. 24, 2009

(30) Foreign Application Priority Data
Aug. 24, 2006 (EP) 06119463.5

(51) Int. Cl. H04B 3/00

(52) U.S. Cl. 340/407.1

(57) ABSTRACT

A device (100) for processing an audio signal (101) and/or a video signal, wherein the device (100) comprises a haptic excitation generating unit (102) adapted for generating a haptic excitation of a specific body part (103) of a user by generating an airflow (104) through a vent (105) in accordance with the audio signal (101) and/or the video signal to be reproduced.

### FIELD OF THE INVENTION

The invention relates to a device for processing an audio signal and/or a video signal.

Beyond this, the invention relates to a method of processing an audio signal and/or a video signal.

Moreover, the invention relates to a program element.

Furthermore, the invention relates to a computer-readable medium.

Beyond this, the invention relates to a method of use.

### BACKGROUND OF THE INVENTION

Audio playback devices become more and more important. Particularly, audio systems comprising audio manipulating features become more and more important.

U.S. Pat. No. 5,513,270 discloses vented loudspeakers for the reproduction of musical sounds, but particularly to the design and location of ports or vents that tune the enclosure. The loudspeaker system has an enclosure, having a front baffle and a pair of loudspeaker drivers mounted in the baffle. The enclosure has a hexagonal cross-section. A pair of vents are each located at a juncture of the vertical side edges of the front baffle and its adjoining panels. The vents lead into the enclosure via a conduit, which ends in an inlet. The inlet is positioned within the enclosure to face the rear of the loudspeaker driver. By this arrangement high to mid frequency sound waves radiated within the boundaries of the enclosure and entering the inlet are substantially attenuated in the conduit and low frequency sound waves radiated within the boundaries of the enclosure are reinforced with sound waves directly radiated from the front of the loudspeaker driver.

U.S. Pat. No. 5,555,554 discloses a headset speaker in which a driver is provided in the dome of a speaker earcup and the dome has at least one vent aperture. The vent hole is closed by a movable closure having a corresponding opening therein that permits the size of the opening into the dome to be logarithmically varied between a fully open and fully closed position. A tube tuned to enhance bass frequencies is provided extending between the driver side and rear of the earcup. An opening to the tube remains fully closed by the movable closure unless the cup vent aperture is fully closed at which time the tube is opened.

WO 1990/16142 discloses a ported reflex speaker enclosure for use in the automotive audio systems industry. The ported reflex speaker enclosure is primarily intended for six by nine inch standard speaker chassis used in automotive audio systems that typically are found as non-enclosed suspended speakers in the trunk compartment of automobiles. The speaker enclosure is a concave body having an oval shaped rim portion for receiving a similarly shaped speaker device, a convex bottom, a first sound fidelity enhancement reflex port for directing sound waves to a listening compartment, a second sound fidelity enhancement in the form of an exhaust hole for controlling sound wave pressure emanated from an enclosed speaker located within the concave body and a third sound fidelity enhancement in the form of equalizing notches that complement the exhaust hole's control of sound wave pressure emanated from an enclosed speaker.

WO 2005/025076 discloses a portable electronic device including a vibrating transducer having a resilient support and a first mass supported by the first resilient support forming a mechanical resonator, and an electrical circuit coupled to the first vibrating transducer to apply a drive signal. A plurality of tactile vibration transducers can work in unison to produce strong tactile stimulus.

It is further known to equip headphones, for instance directed to video game use, with vibrators, which are activated synchronously with the music and strengthen the impact of, for instance, bass sounds. A motor-created vibration may be used to replace the bass missing from the frequency spectrum reproduced by a loudspeaker. The envelope of the missing bass signal may dictate rotation of the motor, and the synchronization between the acoustic and mechanical signal may give the illusion of a full bandwidth reproduction.

However, it may happen with conventional audio playback systems that the perceived, subjective audio playback quality is poor, particularly in the range of bass frequencies.

### OBJECT AND SUMMARY OF THE INVENTION

It is an object of the invention to provide an audio and/or video system having a sufficient subjective audio and/or video playback quality.

In order to achieve the object defined above, a device for processing an audio signal and/or a video signal, a method of processing an audio signal and/or a video signal, a program element, a computer-readable medium and a method of use according to the independent claims are provided.

According to an exemplary embodiment of the invention, a device for processing an audio signal and/or a video signal is provided, wherein the device comprises a haptic excitation generating unit adapted for generating a selective haptic excitation of a specific body part of a user by generating an air flow through a vent in accordance with the audio signal and/or a video signal to be reproduced.

According to another exemplary embodiment of the invention, a method of processing an audio signal and/or a video signal is provided, wherein the method comprises generating a haptic excitation of a specific body part of a user by generating an air flow through a vent in accordance with the audio signal and/or a video signal to be reproduced.

According to yet another exemplary embodiment of the invention, a computer-readable medium (e.g. a CD, a DVD, a USB stick, a floppy disk or a harddisk) is provided, in which a computer program of processing audio and/or visual data is stored which, when being executed by a processor, is adapted to control or carry out a method having the above mentioned features.

According to still another exemplary embodiment of the invention, a program element of processing audio and/or visual data is provided, which program element, when being executed by a processor, is adapted to control or carry out a method having the above mentioned features.

According to yet another exemplary embodiment of the invention, an air flow streaming through a vent of an audio or audio and video playback device and being based on an audio signal is used for directing the air flow to a part, particularly a naked part, of a human body to thereby combine an auditory perception of the audio signal with a tactile perception of the audio signal.

Signal processing, audio and/or visual data management and generation of a haptic excitation stimulus for improving audio and/or video playback quality which may be performed according to embodiments of the invention can be realized by a computer program, that is by software, or by using one or more special electronic optimization circuits, that is in hardware, or in hybrid form, that is by means of software components and hardware components.

The term “haptic” may particularly denote an excitation relating to the sense of touch, like a tactile stimulation. Haptic means may pertain to the technology of touch. There are different types of sensory neurons (mechanoreceptors) involved in the haptic modality. The haptic, or tactile, sensory modality is related to the active sense that can be used to explore the environment.

The term excitation of a “specific” body part may particularly denote that the air flow is intentionally directed (or redirected) to a predefined target body part, and not in an arbitrary or unspecific manner.

The term “portable device” may particularly denote a device which is adapted to be used independent of a fixed configuration. A portable device may be dimensioned, shaped and/or designed so that a (normal or average) human being may carry the portable device during use in a convenient manner. A portable device may have built-in communication components (like antennas) and/or an autonomous power supply (like a rechargeable battery). A portable device may be configured as a one-piece, self-contained device. “Portable devices” may particularly refer to hand-held or wearable devices. The size of portable device may be relatively small so that a user can carry and use the portable device without the necessity to install or mount it at a specific position.

The term “vent” may particularly denote a hole for the escape of gas or air. Such a vent may be formed as a void within an audio playback device (like a loudspeaker) or may be designed as a tubular conduit directing air from an air stream source to a specific target.

According to an exemplary embodiment, adding a simultaneous haptic excitation, to stimulate a body part with an air beam, may enhance an acoustic experience or perception of a user playing back music via a loudspeaker. Particularly in the bass frequency range, in which many audio or audio and video playback devices have only a medium to low audio playback capability, the audio bass feeling may be enhanced with an air stream improving the subjective sound experience. In a scenario in which an audio bass feeling is not strong enough, particularly a non-linear air flow through a vent may then act on the tactile sense of a user, thereby generating an impressive experience due to the synergistic effect of the haptic excitation and the acoustic excitation. According to another exemplary embodiment, adding a simultaneous haptic excitation, to stimulate a body part with an air beam, may enhance an visual experience or perception of a user watching moving pictures on a screen of e.g. a TV set or a monitor.

Therefore, according to an exemplary embodiment, an audio and/or video experience enhancement system may be provided using an acoustic vent output as a haptic excitation signal.

A vented acoustic system according to an exemplary embodiment may be designed in such a way that the air flow coming from the vent is directed to a (for instance naked) part of the body of a user, so as to combine the auditory perception of a bass signal with the tactile sensation of the bass signal. This may be applied particularly advantageously in a scenario in which the vent airflow is put in its non-linear turbulent regime.

In the frequency range in which the vent is active and in which an airflow is sufficient to be felt by the user, this tactile excitation enhances the overall experience (multi-sensory excitation) and may give the user the feeling of a more powerful system.

This effect can in particular be used in small-dimensioned audio devices, for instance portable audio systems, where reinforcement of the perceived (limited) bass may be strongly desirable.

For generating the air stream, a sufficient volume of air needs to be put in motion to create a sufficiently high pressure at a low frequency.

Embodiments of the invention remedy to some extent to the fact that small sound reproduction systems are relatively poor at reproducing low frequencies in a loud way, and therefore fail to convey a sense of “weight” in the audio reproduction.

According to an exemplary embodiment of the invention, a device (which may be operable by a user) is provided, comprising an electro-acoustic transducer for rendering an input signal. Furthermore, an enclosure may be provided comprising a vent and being acoustically loadable by the electro-acoustic transducer, wherein the device may be designed in such a way that the vent outlet of the vent is directed towards a/an (naked) area to be stimulated of the body of a user while the device is operated by the user.

Such a vent may be positioned at a given distance from the area of a user to be stimulated, which distance may be preferably less than five times the diameter of the transducer. According to an exemplary embodiment, the vent may be adapted for producing a turbulent (and/or non-linear) airflow. If only a small enhancement of an audio experience is desired, even a laminar flow may be sufficient.

A sound reproduction part of such a system may comprise or may be incorporated in any device used preferably at a given distance from the body, for instance handheld sound reproduction systems, wearable jackets (for example a jacket with built-in speakers for instance), nearfield sound reproduction systems (for example a headrest of an airplane), a headphone or earphone, or a sound reproduction system further away but with an extension directed to the body of a user (for instance a PC keyboard).

By taking the measures according to exemplary embodiments of the invention, it may be possible to provide an improved perception of low audio frequencies to a user.

Therefore, exemplary fields of application of embodiments of the invention are handheld sound reproducing systems equipped with loudspeakers (audio, A/V players, portable gaming consoles). Any wearable devices, including clothing, may also be equipped with an audio system according to an embodiment of the invention. Furthermore, headphones may be provided, directing a vent to the skin of the ear or the area surrounding the ear. A sound reproducing system may be equipped with loudspeakers, placed at a few centimetres distance from a user (integrated in a plane seat headrest or in a car seat headrest, for instance). Beyond this, sound reproduction systems may be provided which can be placed further away from the user, but using a long extension (tube).

In the following, some considerations will be explained based on which exemplary embodiments of the invention may become understandable.

A vented loudspeaker system may be provided that can create an air flow in vicinity of a vent. Bass reflex loudspeaker boxes are acoustic systems comprising an electro-acoustic transducer, acoustically loaded at the back by a volume of air and a port (vent) opening the box to the outside (often in the shape of a tube).

The air inside the box may be compressible and may act as an acoustic spring. The air inside the vent may act as an acoustic mass and can move inside and outside of the box. When the loudspeaker is operated at frequencies near or below the so-called box resonance (defined by the spring mass system just described), the vent may act as an exhaust pipe and may produce a strong air flow, which can be felt if the user places his or her hand or face or any other sufficiently sensitive body part in front of the vent. This effect may be particularly strong as the airflow from the vent is turbulent.

A multi-sensory excitation (a synchronous excitation of several senses) is a way to enhance or multiply the perceived magnitude of a (monosensoric) stimulus.

In other words, a perceived effect of a “stimulus 1” plus a synchronous “stimulus 2” may be larger and/or better than the “stimulus 1” plus an asynchronous (i.e. not synchronous) “stimulus 2”

Based on the above considerations and recognitions, an audio-haptic excitation mechanism may be provided according to an exemplary embodiment of the invention. According to an exemplary embodiment of the invention, a synchronous tactile one may strengthen an auditory experience. This may be obtained by directing the airflow of an acoustic vent (or port) towards a part of the body of the user which is sensitive to air flow. Therefore, preferably a naked part of a body may be used. Examples for parts of the body, which are specifically sensitive for tactile stimuli, are the hands or the wrists. This may be used particularly in case of handheld devices.

Natural time synchronization and complementary spectrum coverage of the tactile (also named haptic) and auditory stimuli may be obtained by the very properties of the vented acoustic system. The combination of audio and touch may result in an increased awareness of the bass present in the reproduced signal.

In a listening test performed by the inventor with a handheld prototype using a 30 mm diameter driver, five subjects out of five reported that they had the impression of a bigger, more powerful sound system, when they were subjected to the air flow onto their hands, in addition to listening to the audio only.

In the following, some aspects regarding a theoretical basis for embodiments of the invention will be explained.

In a vent acoustic system, two regimes may be distinguished:

above a box resonance frequency: high sound pressure level is produced, little air flow

below a box resonance frequency: high air flow is produced, little sound.

The sound pressure level response of a vented loudspeaker may be a forth-order high pass filter. The main flaw of these systems may be the very limited sound output below the box resonance frequency. Embodiments of the invention may provide the user with the information that is not conveyed acoustically, as a tactile feedback.

In music, which often has harmonic content distributed on both sides of the box resonance, the complete audio spectrum can therefore be conveyed to the user, by the sum of acoustic and tactile contributions. The mechanical action may be synchronous with the acoustical one because the music signal itself is spread over the “acoustic” and “mechanical” regions.

The haptic excitation may be selective. In other words, provision may be made that the excitation may be switched on or off or may be adjusted quantitatively under control of a machine or a user. It may also cover the feature of an excitation that varies over time.

Next, further exemplary embodiments of the device will be explained. However, these embodiments also apply to the methods, to the program element and to the computer-readable medium.

The haptic excitation generation unit may be adapted for generating the haptic excitation of the specific body part, wherein this body part differs from an ear of the user. Specific parts of the human body may be more sensitive with regard to an air stream than the ear that is adapted by nature to be sensitive to an audio stimulus. However, other parts of the human body like a hand, a wrist, a neck, a finger and a face may be appropriate targets for the air stream so as to generate, in a timely synchronized manner, a combined ear based audio perception and other body part based tactile stimulus. Moreover, the entire perception may be more intense when the target of the audio stimulus and the target of the tactile stimulus are different.

The haptic excitation generating unit may be adapted for generating the haptic excitation of the specific body part of the user by directing the air flow onto the specific body part. In other words, a guiding mechanism like a correspondingly curved tube or any other air streaming conduit may be provided to transport the (moving or even accelerated) air flow or air stream to the desired location, and to selectively apply the tactile sensation to this body part.

The haptic excitation generation unit may be adapted for generating the haptic excitation of the specific body part of the user by generating a turbulent airflow. By not only generating a laminar air flow, but for instance a non-linear air stream having a sufficiently high velocity, a sufficient air pressure level and/or eddies, an ecstatic feeling may be generated at the user's skin. Such a turbulent property may be promoted by a fan, a ventilator or any other air acceleration mechanism (for instance by a specific tapering geometry of a conduit forming the vent). In fluid dynamics, turbulence or turbulent flow is a flow regime that may be characterized by low momentum diffusion, high momentum convection and/or rapid variation of pressure and velocity in space and time. A turbulent airflow may be present when the fluid streamlines break into eddies and complex changing patterns. This can cause (desired) unstable forces on the target body part.

The haptic excitation generation unit may be adapted for generating the haptic excitation of the specific body part of the user by generating the air flow through the vent in accordance with a bass portion, particularly exclusively with a bass portion, of the audio signal to be reproduced. Particularly in portable and other small sized audio playback devices, it may be difficult to generate a high quality bass performance. If, selectively for such bass frequencies, an additional haptic excitation is added, this may improve the feeling of the user in this specific frequency range. “Bass” frequencies may be audible frequencies below a predetermined threshold frequency that may be in the range of essentially 20 Hz to essentially 120 Hz, particularly in the range between 40 Hz and 120 Hz, more particularly in the range between 80 Hz and 120 Hz.

More generally, the haptic excitation generating unit may be adapted for generating the haptic excitation of the specific body part of the user by generating the air flow through the vent in accordance with the audio signal in an audio frequency dependent manner. In other words, the haptic excitation may be different for different audio frequencies. By taking this measure, frequency specific audio playback capabilities of an audio playback system may be equilibrated for a better experience of a user. For instance, strong haptic excitations may be generated in frequency domains in which audio play back quality is relatively poor (for instance a bass regime in small playback devices), and weaker or no haptic excitations may be generated in frequency domains in which audio play back quality is better. In some applications the haptic excitation generating unit may be adapted or may also be adapted for generating the haptic excitation of the specific body part of the user by generating the air flow through the vent in accordance with a video signal.

The device may be designed in such a manner that, in an operation state, in which the device is used/carried by the user (for instance mounted on the body of a user), a distance between an outlet of the vent and the specific body part of the user does not exceed a threshold value. Spacers may be provided which may define a minimum distance. Particularly, the distance between an outlet of the vent and the specific body part may be smaller or equal to five times of a diameter of an audio reproduction device, for instance of a loudspeaker. With such a geometrical configuration, a very efficient audio reproduction and combined excitation may be made possible.

The device may further comprise an auditory excitation generating unit adapted for generating a auditory perception of the user by generating acoustic waves in accordance with the audio signal to be reproduced. In other words, the audio excitation generating unit may generate acoustic waves and may therefore be a loudspeaker, a headset, an earpiece or the like. The generation of the acoustic waves and the generation of the airflow may be synchronized or coordinated, particularly by using the same signal, namely the audio signal, as a basis for generating the tactile and the acoustic stimulus. By taking this measure, the haptic excitation may be perceived as an improvement or strengthening of the acoustic performance.

Particularly, the device may be adapted as portable device. Portable devices are in many cases relatively small and may have shortcomings with regard to reproducing bass in a sufficient quality. By adding the tactile stimulus, such a shortcoming in the bass regime may be compensated and thus at least partially overcome.

The device for processing audio and/or visual data may be realized as a handheld sound reproduction system, a wearable device, a near-field sound reproduction system, headphones, earphones, a keyboard of a personal computer, a portable audio player, a loudspeaker, an audio surround system, a mobile phone, a headset, a hearing aid, a handsfree system, a television device, a TV set audio player, a video recorder, a monitor, a gaming device, a laptop, an audio player, a DVD player, a CD player, a harddisk-based media player, an internet radio device, a public entertainment device, an MP3 player, a hi-fi system, a vehicle entertainment device, a car entertainment device, a solarium system, such as Philips Innergize system, a medical communication system, a speech communication device, a home cinema system, a home theater system, an audio server, an audio client, a flat television apparatus, an ambiance creation device, or a music hall system.

Although the system according to an embodiment of the invention primarily intends to improve the quality of sound or audio data, it also intends to improve the quality of video and visual data. Moreover the system is favourably applicable for a combination of audio data and visual data. For instance, an embodiment of the invention may be implemented in audiovisual applications, like a video player or a home cinema system in which one or more speakers are used.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1, FIG. 3 to FIG. 12 illustrate devices for processing an audio signal according to exemplary embodiments of the invention.

FIG. 2 illustrates a diagram describing a functional principle of a device for processing an audio signal according to an exemplary embodiment of the invention.

### DESCRIPTION OF EMBODIMENTS

The illustration in the drawing is schematically. In different drawings, similar or identical elements are provided with the same reference signs.

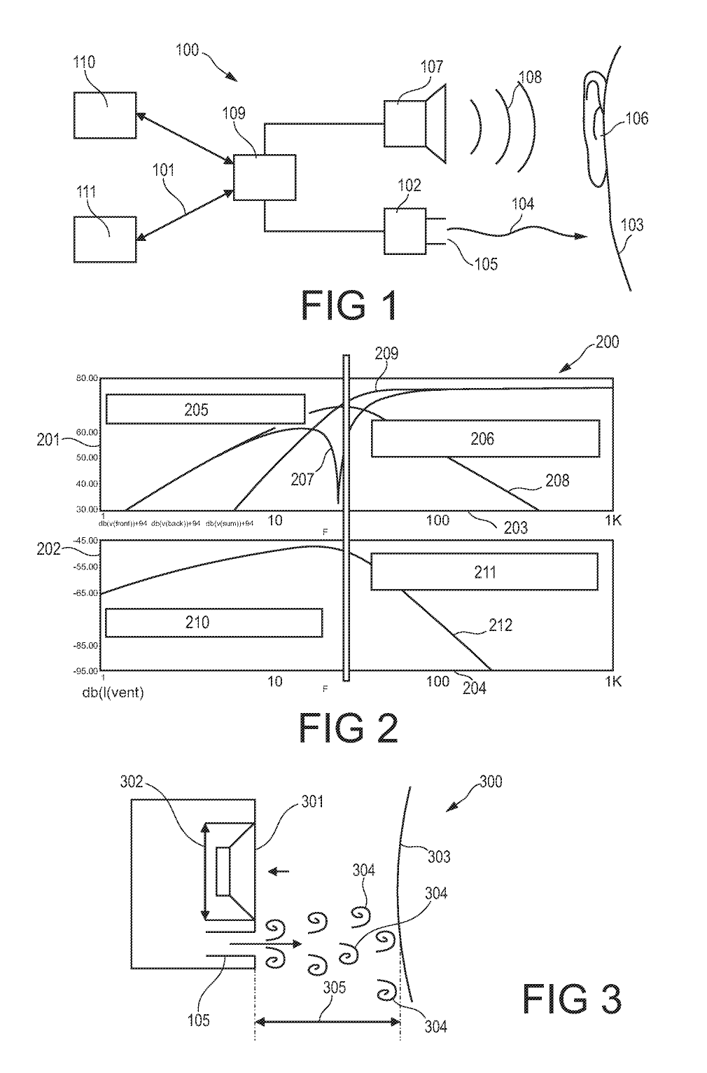

In the following, referring to FIG. 1, a device 100 for processing an audio signal 101 according to an exemplary embodiment of the invention will be explained.

The device 100 comprises an audio data source 111, for instance a CD, a harddisk or even a wired or wireless connection to a remote source, for instance in the context of digital television.

Audio data 101 to be reproduced by the device 100 are transmitted to a control unit 109, which may be a CPU (central processing unit). The CPU 109 has processing capabilities and is capable of processing the audio signal 101 to prepare it for reproduction.

The CPU 109 is in bidirectional communication with an input/output device 110 that allows a user to control the entire system 100. The input/output unit 110 may comprise a display unit like a liquid crystal display, a plasma device or even a cathode ray tube. Furthermore, input elements may be provided at the input/output device 110, like a keypad, a trackball, a mouse, a joystick or even a microphone of a voice recognition system. A user may initiate playback of an audio piece stored on the CD 111 by providing the CPU 109 with corresponding control commands.

Based on these control commands, the audio data 101 are transmitted from the CD 111 to the CPU 109 for processing. The selected audio data 101 is then reproduced by a loudspeaker 107, thereby generating acoustic waves 108 that can be perceived by an ear 106 of a human listener shown schematically in FIG. 1.

Beyond this, the audio signals 101 are also transmitted to a haptic excitation generation unit 102. Component 102 comprises a vent 105 and generates the selective haptic excitation of a neck portion 103 of the user by generating a turbulent airflow 104 through the vent 105 in accordance with the audio signal 101 to be reproduced. Therefore, in addition to the audio perception of the ear 106, the user can experience a haptic signal 104 being a tactile fingerprint of the audio data 101 on the naked skin of the neck 103. By this synergetic perception of audio and tactile stimuli, particularly relatively small audio amplitudes in the bass range may be compensated at least partly, thereby allowing the user to have a better overall experience.

The ear 106 is used for detecting the acoustic waves 108, and the tactile-sensitive neck 103 is used for experiencing or perceiving the turbulent air stream 104. In order to increase the velocity of the air of the air stream 104, it may also be possible that a ventilator or a pump or another air acceleration member (not shown) is provided in the device 100.

It is also possible that only a bass part of the audio data 101 is taken as a basis for generating the tactile stimulus 104, whereas treble and mid-frequency components may be not used for this purpose. Particularly in the bass regime, small devices may have problems of reproducing bass sound with sufficient amplitude, whereas this problem may be less pronounced in the higher frequency ranges.

Additional to or in stead of the audio data source, a visual data source (not depicted) may be provided. In such case a video signal to be reproduced by the device 100 may be transmitted to the control unit 109 for processing, where after the selected visual data may be reproduced on a screen (not depicted), such as a LCD screen or the like. The video signal may also be transmitted to the haptic excitation generation unit 102 for generating a selective haptic excitation of a portion of the user by generating a turbulent airflow through a vent, e.g. the vent 105, in accordance with the video signal.

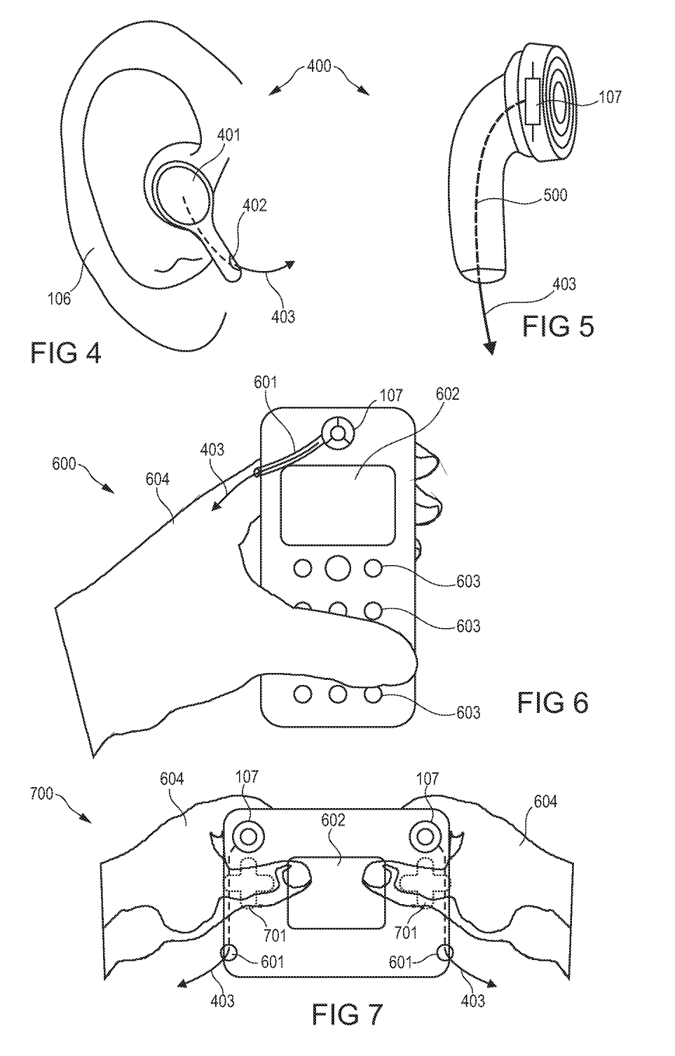

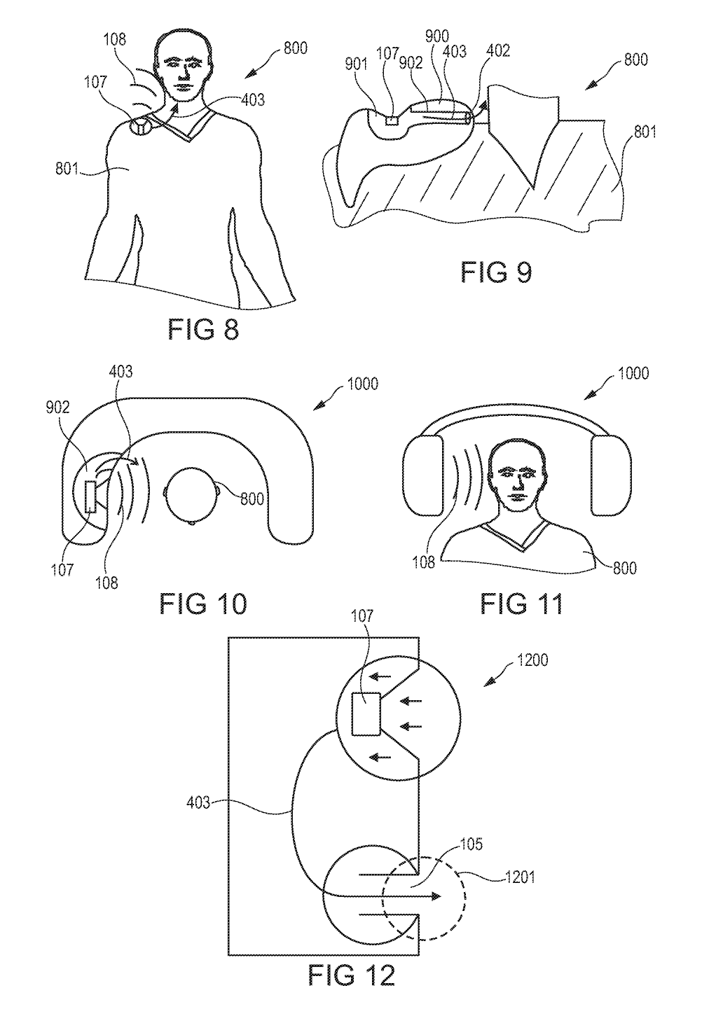

FIG. 2 is a diagram 200 illustrating a dependency of the audio amplitude plotted along ordinates 201, 202 in dependence of a frequency plotted along abscissas 203, 204.

The upper diagram in FIG. 2 shows the sound pressure level (SPL). A low SPL area of sound is denoted with reference numeral 205 and a high SPL area (sound) is denoted with reference numeral 206.

A loudspeaker driver cone output is denoted with reference numeral 207, a vent output is plotted with reference numeral 208, and a total system sound pressure level (cone plus vent) is denoted with reference numeral 209.

The bottom diagram in FIG. 2 shows the airflow at the vent output. A high airflow area (from the vent) is denoted with reference numeral 210, and a low airflow area (from the vent) is denoted with the reference numeral 211. A curve 212 shows the airflow of the vent (assuming a linear flow).

The airflow may be much higher in the vicinity of the vent than at the driver, since the diameter of the vent may be much smaller than that of the driver. The airflow will become very obvious to the user when the turbulent, non-linear regime of the flow in the vent is reached.

Embodiments of the invention provide a way to mechanically (with airflow) stimulate the body of the user with the lower tones of the audio signal that are not properly reproduced acoustically.

According to an exemplary embodiment, a vent is integrated in a sound reproduction product, the mechanical design of the product being such that the vent outlet is:

directed toward a naked part of the body of the person (preferably a highly touch-sensitive part, but in principle it can be any part, for instance hands, wrist, neck, face, etc.).

positioned at a given distance from the body which should be less than five times diameter of the loudspeaker used.

FIG. 3 shows a device 300 according to an exemplary embodiment of the invention.

A loudspeaker driver is denoted with reference numeral 301, and a diameter of the loudspeaker is denoted with reference numeral 302. A user skin is indicated with reference numeral 303. Reference numeral 304 indicates a turbulent airflow. As can be taken from FIG. 3, a vent distance 305 shall be less than five times the loudspeaker diameter 302.

FIG. 4 shows a device 400 according to an exemplary embodiment of the invention implementing an earphone 401.

As can be taken from FIG. 4, a vent opening 402 is directed towards and (nearly) touches skin above the jaw-bone. Therefore, airflow 403 is streaming in the defined direction.

FIG. 5 shows a channel 500 through which a stream of air may flow so that the air stream 403 may be emitted at an end hole.

FIG. 6 shows a handheld device 600 according to another exemplary embodiment of the invention.

The handheld device 600 comprises a loudspeaker 107 and a vent tube 601 at the end of which the airflow 403 is emitted and directed towards a hand 604 of a user. The hand 604 of the user grips the handheld device 600 and is capable of actuating buttons 603. A display device 602 is provided as well. As can further be taken from FIG. 6, the vent 601 opening is directed towards the fingers of the user's hand 604. For example, the handheld device 600 may be a mobile phone on which an acoustic output may also generate a correlated air stream 403 directed towards the skin of the hand 604.

FIG. 7 schematically illustrates a portable gaming console 700 according to an exemplary embodiment of the invention.

Two hands 604 of a user carry the handheld device 700 and operate a cross-like control button 701. A display 602 is shown as well as loudspeakers 107. Vent openings 601 are shown at the end of which an air stream 403 is emitted towards the hands 604.

FIG. 8 shows a human user 800 carrying a wearable jacket 801.

High frequency acoustic waves 108 are emitted by a loudspeaker 107 directly to the ear of the human listener 800. However, the low frequency audio contributions have an amplitude which shall be effectively increased by generating an airflow 403.

FIG. 9 shows a portion of the wearable jacket 800 in more detail.

A collar 900 is shown having a loudspeaker 107 and a vent hole 402. An airflow 403 is directed directly towards the neck of the human 800. An enclosed air volume is denoted with reference numeral 901. A tube 902 is provided for directing the air from the enclosed air volume 901 to the vent hole 402.

FIG. 10 shows a headrest 1000 according to an exemplary embodiment of the invention. Another view of the headrest 1000 is shown in FIG. 11.

The top view of FIG. 10 and the side view of FIG. 11 show the function of the nearfield system 1000.

Such a headrest 1000 may be provided at a seat for a long-haul flight. Again, the user 800 is shown experiencing audio sound 108. For this purpose, a loudspeaker 107 is activated. Additionally, an air stream 403 is generated using a tube 902.

FIG. 12 shows a bass reflex speaker configuration 1200 according to an exemplary embodiment of the invention.

The loudspeaker 107 comprises a moving mass, as shown, as well as the re-directed air stream 403 that is emitted via a vent 105. A zone where the air can be felt is indicated by the reference numeral 1201.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A device (100) for processing an audio signal (101) and/or a video signal, wherein the device (100) comprises a haptic excitation generating unit (102) adapted for generating a haptic excitation of a specific body part (103) of a user by generating an airflow (104) through a vent (105) in accordance with the audio signal (101) and/or the video signal to be reproduced.

2. The device (100) according to claim 1,
wherein the haptic excitation generating unit (102) is adapted for generating the haptic excitation of the specific body part (103) which differs from an ear (106) of the user.

3. The device (100) according to claim 1,
wherein the haptic excitation generating unit (102) is adapted for generating the haptic excitation of the specific body part (103) selected from the group consisting of a hand, a wrist, a neck, a finger, and a face.

4. The device (100) according to claim 1,
wherein the haptic excitation generating unit (102) is adapted for generating the haptic excitation of the specific body part (103) of the user by directing the airflow (104) onto the specific body part (103).

5. The device (100) according to claim 1,
wherein the haptic excitation generating unit (100) is adapted for generating the haptic excitation of the specific body part (103) of the user by generating a turbulent airflow (104).

6. The device (100) according to claim 1, wherein the device is adapted for processing of at least the audio signal, wherein the haptic excitation generating unit (102) is adapted for generating the haptic excitation of the specific body part (103) of the user by generating the airflow (104) through the vent (105) in accordance with a bass portion, particularly exclusively with a bass portion, of the audio signal (101) to be reproduced.

7. The device (100) according to claim 1, wherein the device is adapted for processing of at least the audio signal, wherein the haptic excitation generating unit (102) is adapted for generating the haptic excitation of the specific body part (103) of the user by generating the airflow (104) through the vent (105) in accordance with the audio signal (101) in an audio frequency dependent manner.

8. The device (100) according to claim 1,
designed in such a manner that, in an operation state in which the device (100) is used by the user, a distance between an outlet of the vent (105) and the specific body part (103) of the user does not exceed a threshold value.

9. The device (100) according to claim 1, wherein the device is adapted for processing of at least the audio signal and is designed in such a manner that, in an operation state in which the device (100) is used by the user, a distance between an outlet of the vent (105) and the specific body part (103) of the user does not exceed five times of a diameter of an audio reproduction device (107) for reproducing the audio signal (101).

10. The device (100) according to claim 1, wherein the device is adapted for processing of at least the audio signal and comprises an auditory excitation generating unit (107) adapted for generating an auditory perception of the user by generating acoustic waves (108) in accordance with the audio signal (101) to be reproduced.

11. The device (100) according to claim 10,
adapted in such a manner that the haptic excitation and the auditory perception are synchronized.

12. A method of processing an audio signal (101) and/or a video signal, wherein the method comprises generating a haptic excitation of a specific body part (103) of a user by generating an airflow (104) through a vent (105) in accordance with the audio signal (101) and/or the video signal to be reproduced.

13. A computer-readable medium, in which a computer program of processing an audio signal (101) and/or a video signal is stored, which computer program, when being executed by a processor (109), is adapted to carry out or control the method according to claim 12.

14. A program element of processing an audio signal (101) and/or a video signal, which program element, when being executed by a processor (109), is adapted to carry out or control the method according to claim 12.
